(19) United States
(12) Patent Application Publication
(10) Pub. No.: US 2014/0034331 A1
(43) Pub. Date: Feb. 6, 2014

(54) Fluid Mixture for Softening a Downhole Device

(71) Applicant: Baker Hughes Incorporated, Houston, TX (US)

(72) Inventor: Nicholas L. Carrejo, Katy, TX (US)

(73) Assignee: Baker Hughes Incorporated, Houston, TX (US)

(21) Appl. No.: 13/954,460

(22) Filed: Jul. 30, 2013

Related U.S. Application Data
(60) Provisional application No. 61/678,228, filed on Aug. 1, 2012.

(51) Int. Cl. C09K 8/00; E21B 41/00

(52) U.S. Cl. CPC C09K 8/00; E21B 41/00
USPC 166/376; 166/377

(57) ABSTRACT

A downhole device, having at least a portion polyurethane therein, may be softened by contacting the downhole device with a fluid mixture. The fluid mixture may have at least two components that may be or include, but are not limited to ethylene glycol monobutyl ether (EGMBE), propylene carbonate (PC), methanol, ethylene carbonate, dimethyl ether, diethyl ether, and combinations thereof. Upon contact with the fluid mixture, the downhole device may become softened for subsequent removal and/or retrieval of the downhole device.

### CROSS-REFERENCE TO RELATED APPLICATION

This application claims the benefit of Provisional Patent Application No. 61/678,228 filed Aug. 1, 2012, which is incorporated by reference herein in its entirety.

### TECHNICAL FIELD

The present invention relates to softening a downhole device comprising polyurethane by contacting the downhole device with a fluid mixture for subsequent retrieval of the downhole device.

### BACKGROUND

In the past, sand control methods have been dominated by gravel packing outside of downhole screens. The idea was to fill the annular space outside the screen with sand to prevent the production of undesirable solids from the formation. More recently, with the advent of tubular expansion technology, it was thought that the need for gravel packing could be eliminated if a screen or screens could be expanded in place to eliminate the surrounding annular space that had been packed with sand. However, problems arose with these screen expansion technique, as a replacement for gravel packing, because of wellbore shape irregularities. A fixed swage would only expand a screen a fixed amount. The problems were that a washout in the wellbore would still leave a large annular space outside the screen. Conversely, a tight spot in the wellbore might cause the fixed swage to stick.

One improvement of the fixed swage technique was to use various forms of flexible swages. In theory, these flexible swages were compliant so that in a tight spot they would flex inwardly and reduce the chance of sticking the swage. On the other hand, if there was a void area, the same problem persisted in that the flexible swage had a finite outer dimension to which it would expand the screen. Therefore, the use of flexible swages still left the problem of annular gaps outside the screen with a resulting undesired production of solids when the well was put on production from that zone.

To address this issue, conformable and/or expandable screen assemblies with an outer layer were created that can conform to the borehole shape upon expansion. The material of the screen may be self-swelling or may swell upon contact with a wellbore fluid to further promote filling the void areas in the borehole after expansion. The outermost layer swells to conform to the borehole shape from contact with well fluids or other fluids introduced into the wellbore. The screen section is fabricated in a manner that reduces or eliminates welds. Welds are placed under severe loading in an expansion process, so minimizing or eliminating welds provides for more reliable screen operation after expansion. These and other advantages of the present invention will become more apparent to one skilled in the art from a review of the description of the preferred embodiment and the claims that appear below.

There are many types of polymeric foam commercially available such as natural rubber foam, vinyl rubber foam, polyethylene foam, neoprene rubber foam, silicone rubber foam, polyurethane foam, VITON® rubber foam, polyimide foam, polyurethane foam, etc.

It would be desirable to be able to soften the downhole device made from these conformable foam-like materials in order for the downhole device to be removed and/or retrieved from the wellbore.

### SUMMARY

There is provided, in one form, a method of softening a downhole device having a polyurethane portion. The downhole device may be contacted with a fluid mixture having at least two components where the contact by the fluid mixture softens the downhole device. The two components may be or include, but are not limited to, ethylene glycol monobutyl ether (EGMBE), propylene carbonate (PC), methanol, ethylene carbonate, dimethyl ether, diethyl ether, and combinations thereof.

There is further provided in another non-limiting embodiment a method for retrieving a softened downhole device from a wellbore where the downhole device includes a polyurethane portion. The downhole device may be softened by contact with a fluid mixture having at least two components. The two components may be or include, but are not limited to ethylene glycol monobutyl ether (EGMBE), propylene carbonate (PC), methanol, ethylene carbonate, dimethyl ether, diethyl ether, and combinations thereof.

In another non-limiting embodiment, a softened downhole device may be retrieved from a wellbore where at least a portion of the downhole device comprises polyurethane. The downhole device may be contacted with a fluid mixture comprising at least two components. The contact of the fluid mixture with the downhole device may soften the downhole device. The two components may be or include, but are not limited to ethylene glycol monobutyl ether (EGMBE), propylene carbonate (PC), methanol, ethylene carbonate, dimethyl ether, diethyl ether, and combinations thereof.

The fluid mixture appears to soften the polyurethane portion of the downhole device and allows for subsequent removal and/or retrieval of the softened downhole device from the wellbore.

### DETAILED DESCRIPTION

It has been discovered that a fluid mixture may be used to contact a downhole device having a polyurethane portion where the contact with the fluid mixture softens the polyurethane portion of the downhole device. Polyurethane may be used within a downhole device where it is desirable to have a foam-like quality to the downhole device, and/or where it is desirable for the shape of the downhole device to conform to the wellbore. Downhole devices may suitably have cylindrical polyurethane layers with a thickness ranging from about 0.635 cm independently to about 8.3312 cm, alternatively from about 0.508 cm independently to about 6.35 cm, or from about 0.762 cm independently to about 10.16 cm in another non-limiting embodiment. As used herein with respect to a range, “independently” means that any lower threshold may be used together with any upper threshold to give a suitable alternative range.

In one non-limiting embodiment, once the downhole device is placed downhole, the polyurethane portion may be set and conform to a particular location within the wellbore. The types of polyurethanes that may be softened by the fluid mixture may include polyurethanes that have a memory-foam component. ‘Memory-foam’ is defined herein to mean a polyurethane component where the viscosity and density may be increased. Higher-density memory foam softens in reaction to body heat, allowing it to mold to a warm body in a few minutes. A lower-density memory foam is pressure-sensitive and molds quickly to the shape of a body pressing against it, returning to its original shape once the pressure is removed.

One non-limiting example of a type of polyurethane that may be softened by the fluid mixture is described in U.S. Pat. No. 7,926,565, entitled “Shape Memory Polyurethane Foam for Downhole Sand Control Filtration Devices”, which is incorporated herein by reference in its entirety. Another type of polyurethane that may be softened by the fluid mixture may include, but is not limited to memory foam, shape memory composites, and combinations thereof. “Composite” is defined herein as a material formed from two or more constituent materials different in physical or chemical make up. Here, the shape memory composites are formed from two or more constituent materials, but at least one constituent material that is a polyurethane that has a memory-foam component. A condition may occur allowing the polyurethane to conform to a particular shape, which may be or include, but is not limited to an amount of time, contacting the polyurethane with a fluid different from the “fluid mixture” described herein, and combinations thereof.

Once the polyurethane has conformed to a particular shape and location, e.g. within the wellbore, the fluid mixture may be circulated downhole for contacting the polyurethane of the downhole device. The polyurethane portion may become saturated with the fluid mixture and become softened after a given amount of time. The contact of the fluid mixture may soften the polyurethane, almost to dissolution, for removal and/or retrieval of the downhole device from the wellbore.

A screen is a non-limiting example of a downhole device where at least a portion of the downhole device has a foam component, which is discussed within U.S. Pat. No. 7,318,481, issued on Jan. 15, 2008, and is herein incorporated by reference in its entirety. The screen assembly may have a material that may expand and/or conform to the borehole shape after insertion. However, if the screen (or other type of downhole device having a polyurethane portion) is improperly set or needs to be removed, the fluid mixture may be circulated downhole, soften the screen and then be removed from the wellbore.

The contact with the fluid mixture may lower the T_{g} of the polyurethane of the downhole device to a temperature ranging from about 200 degrees F. (about 93.3 C) independently to about 40 F (about 4 C), or alternatively from about 266 F (about 130 C) independently to about 40 F (about 4 C). In one non-limiting instance, the T_{g} may be lowered to a temperature below about 75 F (about 23.9 C). The T_{g} of the polyurethane prior to being contacted with the fluid mixture may range from about 203 F (about 95 C) independently to about 221 F (about 105 C), alternatively from about 257 F (about 125 C) independently to about 275 F (about 135 C), or from about 221 F (about 105 C) independently to about 230 F (about 110 C) in another non-limiting embodiment.

Upon contact with the fluid mixture, the polyurethane portion may be softened by a method, such as, but not limited to, breaking the chemical bonds of the polyurethane, physically altering the polyurethane, and combinations thereof. The method of softening occurs in an irreversible manner, i.e. once the downhole device has been softened, the device may not be ‘unsoftened’. The downhole device may become softened in at least 5 hours, alternatively from about 5 hours independently to about 48 hours, or from about 5 hours independently to about 24 hours in another non-limiting embodiment.

The softening of the downhole device may occur by dissolving the polyurethane portion or complete deterioration of the polyurethane portion, but at a minimum, the polyurethane portion may become sponge-like or malleable in a manner that allows for easier retrieval or removal of the downhole device once the polyurethane portion is softened. The softened downhole device may be retrieved or removed if the softened downhole device is still in a form capable of being retrieved by a method known to those skilled in the art. ‘Removal” in reference to the downhole device is defined herein to mean that the downhole device has been dislodged from its position within the wellbore to allow someone to pull the softened downhole device out of the wellbore. “Retrieval” is defined herein to mean that the downhole device is pulled out of the wellbore by a mechanism known to those skilled in the art. The downhole device may become so deteriorated that the downhole device may rip apart during retrieval of it from the wellbore. These leftover pieces may be either washed out, pumped out, or milled through to prevent the need to drill around the segment of the wellbore containing the pieces broken off from the softened downhole device.

The temperature for using the fluid mixture for softening of the downhole device may range from about 55 F (about 13 C) independently to about 190 F (about 87.8 C), alternatively from about 130 F (about 54.4 C) independently to about 105 F (about 40.6 C), or from about 195 F (about 90.6 C) independently to about 165 F (about 73.9) in another non-limiting embodiment. Higher temperatures within these ranges allow for quicker deterioration of the downhole device once the fluid mixture contacts the downhole device.

The fluid mixture may have at least two components that may be or include, but are not limited to, ethylene glycol monobutyl ether (EGMBE), propylene carbonate (PC), methanol, ethylene carbonate, dimethyl ether, diethyl ether, and combinations thereof. In theory, PC and/or EGMBE may each be used alone to accomplish the tasks of softening the polyurethane portion, but it has been surprisingly discovered that the combination of PC and EGMBE have a synergistic effect when used together for this purpose.

The amount of the EGMBE may range from about 1 vol % independently to about 99 vol % within the fluid mixture. The amount of the PC may range from about 1 vol % independently to about 99 vol % within the fluid mixture. The ratio of the EGMBE to PC may also depend on the present temperature when the fluid mixture contacts the downhole device. At the higher end of the temperature range, less PC may be used to accomplish the same objective.

In one non-limiting example, the amount of EGMBE is 10 vol % of the fluid mixture and the amount of PC may be 90 vol % of the fluid mixture. Other non-limiting ratios of EGMBE and PC within the fluid mixtures may include, but are not limited to, about 5 vol % of EGMBE to about 95 vol % of PC, about 15 vol % EGMBE to about 85 vol % PC, or about 20 vol % EGMBE to about 80 vol % of PC. And at very high temperatures, such as 200 F (about 93.3 C) in one non-limiting embodiment, EGMBE may be used by itself, but EGMBE is much more effective when used in conjunction with the PC, as previously mentioned.

Methanol may be another optional component to be included in the fluid mixture to aid in softening of the downhole device. Methanol may be a component of the fluid mixture in an amount ranging from about 1 vol % independently to about 29 vol %, alternatively from about 15 vol % independently to about 25 vol %, or from about 5 vol % independently to about 10 vol % in another non-limiting embodiment. Of course, when methanol is added to the fluid mixture, the amounts of other components must be adjusted within the fluid mixture. The methanol may be used as one of the ‘two components’ within the fluid mixture, e.g. EGMBE and methanol; or methanol may be used as a third component, e.g. EGMBE, PC, and methanol.

The fluid mixture may be added to or part of an aqueous-based fluid, such as but not limited to drilling fluids, completions fluids, and combinations thereof. The aqueous-based fluid may include the fluid mixture in an amount greater than 10 vol % of the total aqueous-based fluid, or from about 1 vol % independently to about 40 vol %, or from about 5 vol % independently to about 25 vol % in an alternative embodiment. Said differently, the aqueous-based fluid may range from about 10 vol % independently to about 99 vol % of the total fluid mixture, or from about 60 vol % independently to about 98 vol %, or from about 75 vol % independently to about 95 vol %.

Drilling fluids are typically classified according to their base fluid. In aqueous-based fluids, solid particles are suspended in a continuous phase consisting of water or brine. Oil can be emulsified in the water, which is the continuous phase. “Aqueous-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

A completion fluid may be placed in a well to facilitate final operations prior to initiation of production. Completion fluids are typically brines, such as chlorides, bromides, formates, but may be any non-damaging fluid having proper density and flow characteristics. Completion fluids also help place certain completion-related equipment, such as gravel packs, without damaging the producing subterranean formation zones. Conventional drilling fluids are rarely suitable for completion operations due to their solids content, pH, and ionic composition. The completion fluid should be chemically compatible with the subterranean reservoir formation and its fluids.

The invention will be further described with respect to the following Examples, which are not meant to limit the invention, but rather to further illustrate the various embodiments.

### EXAMPLES

Several compositions were tested at various temperatures, which is noted in TABLE 1 below. The compositions tested had varying amounts (where each component was measured in wt % of the total fluid composition) of at least one of Ethylene Glycol MonoButyl Ether (EGMBE), Methyl Alcohol (MeOH), Ethyl Alcohol (EtOH), Isopropyl Alcohol (IPA), and combinations thereof. These compositions were tested at temperatures, 105° F. (about 40.6 C), 110° F. (about 43.3 C), 115° F. (about 46.1 C), 125° F. (about 51.7 C), 135° F. (about 57.2 C), and 145° F. (about 62.8 C). The time frame noted under a given temperature refers to a target deployment, i.e. the amount of time (in hours) the composition took to reach the formation and was considered ‘deployed’ at a specific temperature. The text stating ‘never’ under a specific temperature indicates that the specific composition did not reach the formation and/or was not considered ‘deployed’.

TABLE 1

| Fluid | | | | | | | | | | |
|---|---|---|---|---|---|---|---|---|---|---|
| Sample | EGMBE | MeOH | IPA | Brine | 105° F. | 110° F. | 115° F. | 125° F. | 135° F. | 145° F. |
| 1 | 1 | 25 | | KCl | | | never | | <8 | |
| 2 | 1 | 10 | | KCl | | | | never | <8 | |
| 3 | 0.5 | 10 | | KCl | | | | | <8 | |
| 4 | 0.5 | 20 | | KCl | | | | | <8 | <8 |
| 5 | 1 | 0 | | KCl | | | | never | never | 9 |
| 6 | 0.5 | 0 | | KCl | | | | | | 12 |
| 7 | 15 | 0 | | KCl- | 110 | | 24 | | | |
| | | | | uWash | | | | | | |
| 8 | 5 | 0 | | KCl- | | | 120 | | | |
| | | | | uWash | | | | | | |
| 9 | 20 | 0 | | KCl- | | | 22 | | | |
| | | | | uWash | | | | | | |
| 10 | 10 | 0 | | Propylene | | | 10 | | | |
| | | | | Carbonate | | | | | | |
| 11 | 2 | 25 | | KCl | | | 28 | <8 | <8 | |
| 12 | 20 | 0 | | Propylene | | | 8 | | | |
| | | | | Carbonate | | | | | | |
| 13 | 0 | 0 | | Propylene | | | 24 | | | |
| | | | | Carbonate | | | | | | |
| 14 | | 50 | | KCL | | | 22 | | | |
| 15 | | 25 | | KCl- | | | never | | | |
| | | | | uWash | | | | | | |
| 16 | 3 | 25 | | KCl | | | 20 | | | |
| 17 | 10 | 25 | | Na Br | 60 | 27 | 9 | 6 | | |
| 18 | 10 | 25 | | Na Br | | | 18 | | | |
| 19 | 10 | 20 | | Na Br | | | 11 | | | |
| 20 | 25 | 10 | | Na Br | never | | | | | |
| 21 | 25 | 5 | | Na Br | | | | | | |
| 22 | 15 | 15 | | Na Br | never | | | | | |
| 23 | | 25 | | Na Br | never | | | | | |
| 24 | 2 | | | KCl | | | | never | never | |
| 25 | 3 | | | KCl | | | | never | never | |
| 26 | 0.5 | 25 | | KCl | | | | <8 | | |
| 27 | 4 | | | KCl | | | | never | never | |
| 28 | 5 | 15 | | KCl | | | 11 | 7 | 2 | |
| 29 | 4 | 15 | | KCl | | | | 8 | 3 | |
| 30 | 3 | 15 | | KCl | | | | 13 | 3.5 | |
| 31 | 2 | 15 | | KCl | | | | 17 | 4 | |
| 32 | 1 | 15 | | KCl | | | | | 4 | |
| 33 | 1 | 10 | | KCl | | | | | 10 | |
| 34 | 1 | 5 | | KCl | | | | | never | |
| 35 | 0.75 | 25 | | KCl | | | | <8 | | |
| 36 | 0.5 | 0 | | KCl | | | | | never | |
| 37 | 5 | 15 | | KCl | | | | | 4 | |
| 38 | 7.5 | 25 | | KCl | 37 | | | | | |
| 39 | 10 | 25 | | KCl | 26 | | | | | |

In the foregoing specification, the invention has been described with reference to specific embodiments thereof, and has been described as effective in providing methods for softening at least a portion of a downhole device having a polyurethane portion. However, it will be evident that various modifications and changes can be made thereto without departing from the broader spirit or scope of the invention as set forth in the appended claims. Accordingly, the specification is to be regarded in an illustrative rather than a restrictive sense. For example, specific components, ratios of the components, aqueous fluids, polyurethanes, downhole devices, and temperature ranges falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of a method for softening at least a portion of polyurethane portion of a downhole device where the downhole device may be contacted with a fluid mixture and subsequently soften the downhole device where the fluid mixture may have two components including but not limited to ethylene glycol monobutyl ether (EGMBE), propylene carbonate (PC), methanol, ethylene carbonate, dimethyl ether, diethyl ether, and combinations thereof.

The words “comprising” and “comprises” as used throughout the claims, are to be interpreted to mean “including but not limited to” and “includes but not limited to”, respectively.

What is claimed is:

1. A method for softening at least a portion of a downhole device comprising a polyurethane portion, the method comprising:
contacting the downhole device with a fluid mixture comprising at least two components and thereby softening the downhole device; wherein the at least two components are selected from the group consisting of ethylene glycol monobutyl ether (EGMBE), propylene carbonate (PC), methanol, ethylene carbonate, dimethyl ether, diethyl ether, and combinations thereof.

2. The method of claim 1, wherein the at least two components have a first component and a second component, and wherein the ratio of the first component to the second component ranges from about 1 vol % to about 99 vol % of the first component and from about 1 vol % to about 99 vol % of the second component.

3. The method of claim 1, wherein the fluid mixture further comprises an aqueous-based fluid selected from the group consisting of drilling fluids, completions fluids, brines, and combinations thereof.

4. The method of claim 3, wherein the fluid mixture comprises the aqueous-based fluid in an amount less than about 99 vol % of the total fluid.

5. The method of claim 1, wherein the polyurethane is a material selected from the group consisting of polycarbonate polyurethane foam, solid polyurethane composite, and combinations thereof.

6. The method of claim 1 further comprising removing the softened downhole device within the wellbore.

7. The method of claim 1, wherein the softening of the downhole device occurs by a method selected from the group consisting of breaking the chemical bonds of polyurethane in the downhole device, physically altering the downhole device, and combinations thereof.

8. The method of claim 1, wherein the softening the downhole device occurs by an irreversible method.

9. The method of claim 1, wherein the softening of the downhole device occurs at a temperature range of about 55 F (about 12.8 C) or higher.

10. A method comprising:
removing a softened downhole device comprising a polyurethane portion from a wellbore, wherein the softened downhole device was contacted with a fluid mixture comprising at least two components, wherein the at least two components are selected from the group consisting of ethylene glycol monobutyl ether (EGMBE), propylene carbonate (PC), methanol, ethylene carbonate, dimethyl ether, diethyl ether, and combinations thereof.

11. The method of claim 10, wherein the at least two components have a first component and a second component, and wherein the ratio of the first component to the second component ranges from about 1 vol % to about 99 vol % of the first component and from about 1 vol % to about 99 vol % of the second component.

12. The method of claim 10, wherein the fluid mixture further comprises an aqueous-based fluid selected from the group consisting of drilling fluids, completions fluids, brines, and combinations thereof.

13. The method of claim 12, wherein the fluid mixture comprises the aqueous-based fluid in an amount less than about 99 vol % of the total fluid.

14. The method of claim 10, wherein the softening of the downhole device occurs by a method selected from the group consisting of breaking the chemical bonds of the polyurethane in the downhole device, physically altering the downhole device, and combinations thereof.

15. The method of claim 10, wherein the softening the downhole device occurs by an irreversible method.

16. The method of claim 10, wherein the softening of the downhole device occurs at a temperature range of at least 55 F (about 12.8 C) or higher.

17. The method of claim 10, wherein the polyurethane is a material selected from the group consisting of polycarbonate polyurethane foam, solid polyurethane composite, and combinations thereof.

18. A method of removing a downhole device comprising a polyurethane portion, the method comprising:
contacting at least a portion of the downhole device with a fluid mixture thereby softening the downhole device; wherein the fluid mixture comprises an aqueous-base fluid and at least two components selected from the group consisting of ethylene glycol monobutyl ether (EGMBE), propylene carbonate (PC), methanol, ethylene carbonate, dimethyl ether, diethyl ether, and combinations thereof; and
removing the softened downhole device from the wellbore.

19. The method of claim 18, wherein the softening the downhole device occurs by an irreversible method.

20. The method of claim 18, wherein the aqueous-based fluid is selected from the group consisting of drilling fluids, completions fluids, brines and combinations thereof.
